(19) United States
(12) Patent Application Publication
(10) Pub. No.: US 2025/0214094 A1
(43) Pub. Date: Jul. 3, 2025

(54) SHOWERHEAD AND SHOWER DEVICE

(71) Applicant: FUJIAN XIHE SANITARY WARE TECHNOLOGY CO., LTD., Fujian (CN)

(72) Inventors: Xiaofa Lin, Fujian (CN); Xiaoshan Lin, Fujian (CN); Zhennan Chen, Fujian (CN); Zhaoping Zheng, Fujian (CN); Jingwen Li, Fujian (CN); Feiming Deng, Fujian (CN); Xiaoqing Deng, Fujian (CN); Kunpeng Huang, Fujian (CN); Qiqiao Liu, Fujian (CN)

(73) Assignee: FUJIAN XIHE SANITARY WARE TECHNOLOGY CO., LTD., Fujian (CN)

(21) Appl. No.: 18/429,745

(22) Filed: Feb. 1, 2024

(30) Foreign Application Priority Data
Dec. 27, 2023 (CN) 202323597429.7

(51) Int. Cl. B05B 1/18; B05B 12/00

(52) U.S. Cl. CPC B05B 1/185; B05B 12/002

(57) ABSTRACT

A showerhead and a shower device are disclosed. The showerhead includes a water outlet disk, a water outlet jacket and a face cover arranged in sequence along a water outlet direction. The water outlet disk is provided with a plurality of communication holes, which communicate with the first water cavity and the second water cavity. The water outlet jacket is also provided with a plurality of elastic sealing caps, and the face cover is provided with a plurality of support structures in one-to-one correspondence with the elastic sealing caps. The elastic sealing caps are configured to block the communication holes when the showerhead is turned off, and when the showerhead is turned on, the elastic sealing caps can be pressed by the water passing through the communication holes to deform so as to open the communication holes. The support structures are configured to support the elastic sealing caps.

### CROSS-REFERENCE TO RELATED APPLICATIONS

This application claims priority to and the benefit of Chinese Patent Application No. 202323597429.7, filed Dec. 27, 2023, the content of which is incorporated herein by reference.

### TECHNICAL FIELD

The present application relates to the technical field of sanitary ware, and in particular to a showerhead and a shower device.

### BACKGROUND

At present, after a showerhead on the market is turned off, a water flow from a water supply system into the showerhead stops, but there is still water left in the showerhead, which cannot be emptied quickly, but drips continuously from water outlet nozzles of the showerhead for a long time. As consumer's requirements for quality of life are getting higher and higher, the dripping of residual water may affect user's experience of using products.

### SUMMARY

An embodiment of the present application provides a showerhead, which includes a water outlet disk, a water outlet jacket and a face cover arranged in sequence along a water outlet direction. A first water cavity is provided at a side of the water outlet disk facing away from the water outlet jacket, and a second water cavity is provided between the water outlet disk and the water outlet jacket. The water outlet disk is provided with a plurality of communication holes which are communicated with the first water cavity and the second water cavity on two sides of the water outlet disk. The water outlet jacket is provided with a plurality of water outlet nozzles communicated with the second water cavity, and the face cover is provided with a plurality of water outlet holes respectively in one-to-one correspondence with the water outlet nozzles. The water outlet jacket is also provided with a plurality of elastic sealing caps protruding towards the communication holes and in one-to-one correspondence with the communication holes. A plurality of support structures in one-to-one correspondence with the elastic sealing caps are provided at a side of the face cover facing the water outlet jacket. The elastic sealing caps are configured to block the communication holes when the showerhead is turned off. When the showerhead is turned on, the elastic sealing caps can be pressed by the water passing through the communication holes to deform so as to open the communication holes. The support structures are configured to support the elastic sealing caps when the elastic sealing caps are pressed to deform, so that the elastic sealing caps can bounce up and block the communication holes when the showerhead is turned off.

In an embodiment, a top of each of the elastic sealing caps forms a recessed portion and an annular sealing portion around the recessed portion. The annular sealing portion abuts against the water outlet disk around the communication hole to seal the communication hole.

In an embodiment, each of the support structures has a central cavity, and the elastic sealing cap is deformed towards the central cavity when the elastic sealing cap is pressed by water passing through the communication hole.

In an embodiment, each of the support structures includes a support rib around the central cavity, and each of the support structures is provided with a communication opening that communicates the central cavity to the outside.

In an embodiment, each of the elastic sealing caps has a sealing cap cavity opening toward the face cover, the recessed portion forms a protrusion protruding into the sealing cap cavity, and the annular sealing portion forms an annular notch around the protrusion within the sealing cap cavity. Each of the support structures includes a support rib protruding toward the sealing cap cavity, and the support rib is annularly arranged to form a central cavity at a central position. The support rib includes a first rib portion and a second rib portion located above the first rib portion, and the second rib portion corresponds to the annular notch. A width of the second rib portion in a radial direction is less than a width of the first rib portion.

In an embodiment, the showerhead also includes a sealing disk, and the first water cavity is formed between the sealing disk and the water outlet disk. The first water cavity includes a central water cavity at a central position of the water outlet disk and a plurality of first water division cavities communicated with the central water cavity and arranged along a circumferential direction. The plurality of communication holes are divided into a plurality of groups, and each of the first water division cavities corresponds to one group of communication holes.

In an embodiment, each of the first water division cavities includes a plurality of communication hole regions and a channel communicating two adjacent communication hole regions. The plurality of communication hole regions are in one-to-one correspondence with a plurality of communication holes in one group of communication holes, respectively.

In an embodiment, the second water cavity includes a plurality of second water division cavities which are communicated with the plurality of communication holes in one-to-one correspondence respectively. The plurality of water outlet nozzles are divided into a plurality of groups, and each of the second water division cavities are correspondingly communicated with one group of water outlet nozzles.

In an embodiment, a raised first water barrier strip is provided on a surface of the sealing disk facing the water outlet disk, and the first water barrier strip abuts against the water outlet disk to form the central water cavity and the plurality of first water division cavities.

In an embodiment, each of the second water division cavities includes a central region corresponding to the communication hole, a plurality of water outlet regions, and channels for communicating the plurality of water outlet regions to the central region. The plurality of water outlet regions are in one-to-one correspondence with a plurality of water outlet nozzles in one group of water outlet nozzles respectively.

In an embodiment, a second water barrier strip is provided on a surface of the water outlet disk facing the water outlet jacket, and the second water barrier strip abuts against the water outlet jacket to divide a space between the water outlet disk and the water outlet jacket so as to form the plurality of second water division cavities.

An embodiment of the present application also provides a shower device including the showerhead as described above.

According to the technical schemes provided by the embodiments of the present application, when the showerhead is turned on, the water enters the communication holes to press and deform the elastic sealing caps, so that the water in the first water cavity can enter the second water cavity through the communication holes, and the water in the second water cavity can flow out of the water outlet holes of the face cover through the water outlet nozzles. When the showerhead is turned off, the elastic sealing caps bounce up and block the communication holes, thus isolating the water in the first water cavity and a water inlet end, while only a small amount of water left in the second water cavity cannot drip out of the water outlet nozzles under the action of atmospheric pressure and the self-adsorption force of water droplets, thus achieving the purpose of immediately stopping the water flow upon turning off the showerhead. By means of providing the support structures so that the elastic sealing caps are supported by the support structures when the elastic sealing caps are squeezed and deformed, the embodiments of the present application can solve the problem that the elastic sealing caps cannot bounce up when they are squeezed onto the face cover. Especially when the elastic sealing caps are made of an elastic rubber material, the elastic sealing caps may be adsorbed on the face cover, thereby the elastic sealing caps cannot bounce up to seal the communication holes. Therefore, the schemes provided by the embodiments of the present application can ensure that each elastic sealing cap can bounce up to seal the communication hole when the showerhead is turned off, thereby realizing the quick water stop function of the showerhead.

Additional features and advantages of the present application will be set forth in the description which follows, and in part will become apparent from the description, or may be learned by practice of the present application. The objects and other advantages of the present application can be realized and obtained by the structures particularly indicated in the description and drawings.

### BRIEF DESCRIPTION OF THE DRAWINGS

The drawings are used for providing a further understanding of technical schemes of the present application, and constitute a part of the description. They are used together with embodiments of the present application to explain the technical schemes of the present application, and do not constitute a restriction on the technical schemes of the present application.

FIG. 1 is a schematic diagram of a structure of a showerhead according to an embodiment of the present application;

FIG. 2 is a schematic diagram of a cross-sectional structure of the showerhead shown in FIG. 1;

FIG. 3 is an enlarged view at A in FIG. 2;

FIG. 4 is a schematic diagram of a structure of the showerhead shown in FIG. 1 in an exploded state;

FIG. 5 is a schematic diagram of a structure of the showerhead shown in FIG. 1 in an exploded state from another angle;

FIG. 6 is a schematic diagram of a structure of a sealing disk according to an embodiment of the present application;

FIG. 7 is a schematic diagram of a structure of a water outlet disk according to an embodiment of the present application;

FIG. 8 is an enlarged schematic view at B in FIG. 7;

FIG. 9 is a schematic diagram of a structure of a water outlet jacket according to an embodiment of the present application;

FIG. 10 is an enlarged schematic view at C of FIG. 9;

FIG. 11 is a schematic diagram of a structure of a face cover according to an embodiment of the present application; and

FIG. 12 is an enlarged schematic diagram at D of FIG. 11.

### DESCRIPTION OF REFERENCE SIGNS

1—showerhead body; 2—sealing disk; 20—first water cavity; 21—first water barrier strip; 22—bolt hole; 23—central connection part; 231—water inlet hole; 201—central water cavity; 202—first water division cavity; 3—water outlet disk; 31—communication hole; 32—second water barrier strip; 33—first passage hole; 30—second water cavity; 301—central region; 302—water outlet region; 303—channel; 4—water outlet jacket; 41—water outlet nozzle; 42—elastic sealing cap; 421—recessed portion; 422—annular sealing portion; 43—sealing cap cavity; 431—annular notch; 44—second passage hole; 5—face cover; 51—water outlet hole; 52—support structure; 521—first rib portion; 522—second rib portion; 523—central cavity; 524—communication opening; 53—bolt fixing post; 6—ball head; 7—connection sleeve; 8—ball head sleeve; 9—sealing ring; 10—gasket; 11—bolt.

### DETAILED DESCRIPTION

In order to make the objectives, technical schemes and advantages of the present application clearer, embodiments of the present application will be described in detail below in connection with the drawings. It should be noted that the embodiments in the present application and the features in the embodiments may be arbitrarily combined with each other if there is no conflict.

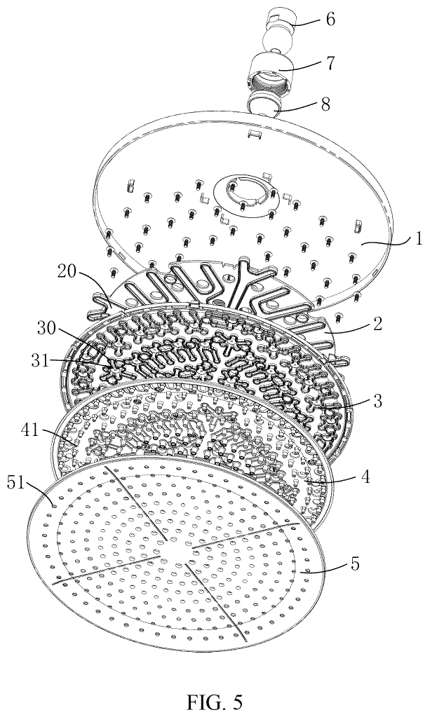

An embodiment of the present application provides a showerhead. As shown in FIGS. 1-5, the showerhead includes a water outlet disk 3, a water outlet jacket 4 and a face cover 5 arranged in sequence along a water outlet direction. A first water cavity 20 is provided at a side of the water outlet disk 3 facing away from the water outlet jacket 4, and a second water cavity 30 is provided between the water outlet disk 3 and the water outlet jacket 4.

The water outlet disk 3 is provided with a plurality of communication holes 31, and the communication holes 31 are communicated with the first water cavity 20 and the second water cavity 30 on two sides of the water outlet disk 3. The water outlet jacket 4 is provided with a plurality of water outlet nozzles 41 communicated with the second water cavity 30, and the face cover 5 is provided with a plurality of water outlet holes 51 respectively in one-to-one correspondence with the water outlet nozzles 41. As shown in FIG. 1, the water outlet nozzles 41 can extend out of the water outlet holes 51 to the outside of the face cover 5.

The water outlet jacket 4 is also provided with a plurality of elastic sealing caps 42 protruding towards the communication holes 31 and in one-to-one correspondence with the communication holes 31. A plurality of support structures 52 in one-to-one correspondence with the elastic sealing caps 42 are provided at a side of the face cover 5 facing the water outlet jacket 4. The elastic sealing caps 42 are configured to block the communication holes 31 when the showerhead is turned off, and when the showerhead is turned on, the elastic sealing caps 42 can be pressed and deformed by the water in the communication holes 31 to open the communication holes 31. The support structures 52 are configured to support the elastic sealing caps 42 when the elastic sealing caps 42 are pressed to deform, so that the elastic sealing caps 42 can bounce up and block the communication holes 31 when the showerhead is turned off.

According to a technical scheme provided by the embodiment of the present application, the water flow in the communication holes 31 can press the elastic sealing caps 42 to deform them when the showerhead is turned on, so that the water in the first water cavity 20 can enter the second water cavity 30 through the communication holes 31, and the water in the second water cavity 30 can flow out of the water outlet holes 51 of the face cover 5 through the water outlet nozzles 41. When the showerhead is turned off, the elastic sealing caps 42 bounce up and block the communication holes 31, thus isolating the water in the first water cavity 20 and a water inlet end, while only a small amount of water left in the second water cavity 30 cannot drip out of the water outlet nozzles 41 under the action of atmospheric pressure and the self-adsorption force of water droplets, thus achieving the purpose of immediately stopping the water flow upon turning off the showerhead. By means of providing the support structures 52 so that when the elastic sealing caps 42 are squeezed and deformed, the elastic sealing caps 42 are supported by the support structures 52, the embodiment of the present application can solve the problem that the elastic sealing caps 42 cannot bounce up when they are squeezed onto the face cover 5. Especially when the elastic sealing caps 42 are made of an elastic rubber material, the elastic sealing caps 42 may be adsorbed on the face cover 5, thereby the elastic sealing caps 42 cannot bounce up to seal the communication holes 31. Therefore, the scheme provided by the embodiment of the present application can ensure that each elastic sealing cap 42 can bounce up to seal the communication hole 31 when the showerhead is turned off, thereby realizing the quick water stop function of the showerhead.

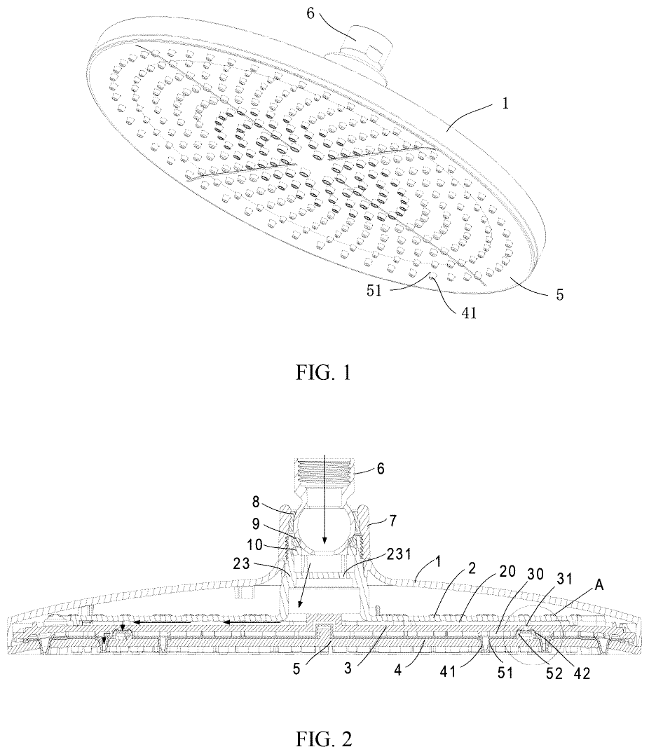

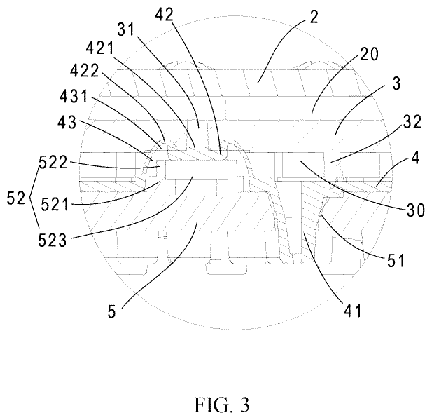

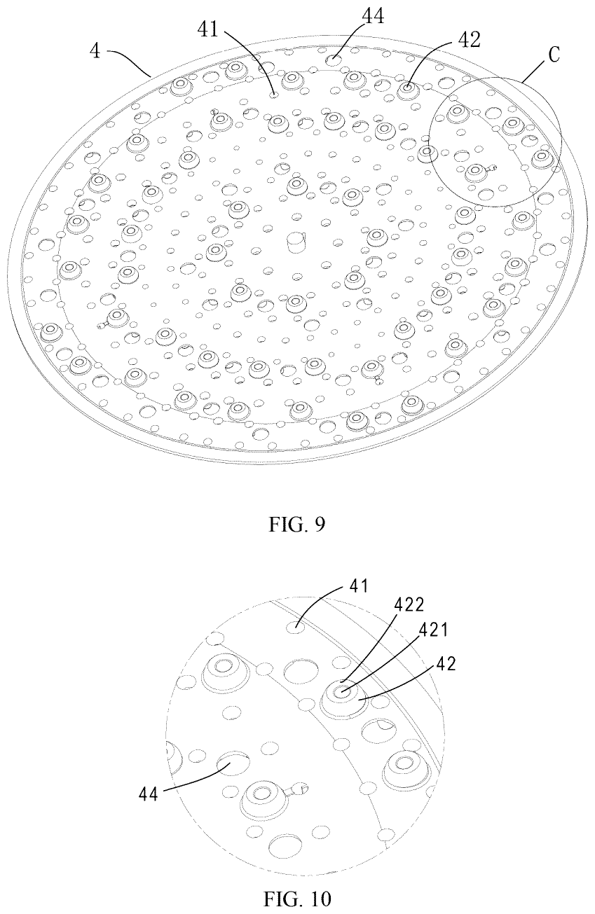

In an embodiment, as shown in FIGS. 2 and 3 (in conjunction with FIGS. 9 and 10), the top of the elastic sealing cap 42 forms a recessed portion 421 and an annular sealing portion 422 around the recessed portion 421. The annular sealing portion 422 abuts against the water outlet disk 3 and surrounds the communication hole 31 to seal the communication hole 31. In this way, when the showerhead is turned on, the water flow in the communication hole 31 can press the recessed portion 421, thereby easily deforming the elastic sealing cap 42 to open the communication hole 31.

In an embodiment, the support structure 52 has a central cavity 523. The elastic sealing cap 42 is deformed towards the central cavity 523 when the elastic sealing cap 42 is pressed by the water in the communication hole 31, i.e., the support structure 52 has a space available for deformation of the elastic sealing cap 42.

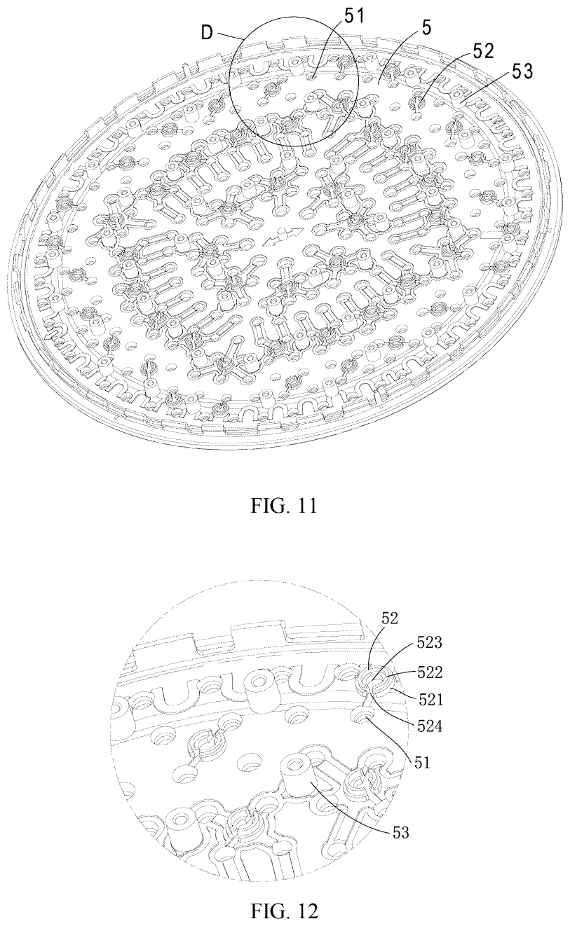

As shown in FIGS. 11 and 12, the support structure 52 includes a support rib disposed around the central cavity 523, and the support rib is provided with a communication opening 524 that communicates the central cavity 523 to the outside. By disposing the central cavity 523 in communication with the outside, the central cavity 523 is ventilated, and the condition where the elastic sealing cap 42 is adsorbed by the central cavity 523 can be avoided. FIG. 12 shows that the central cavity 523 is communicated with the water outlet hole 51 in the face cover 5 through the communication opening 524 to enable ventilation of the central cavity 523.

In an example, the support structure 52 is fitted with the elastic sealing cap 42 as shown in FIG. 3. In this example, the top of the elastic sealing cap 42 forms a recessed portion 421 and an annular sealing portion 422 around the recessed portion 421, and the annular sealing portion 422 abuts against the water outlet disk 3 around the communication hole 31 to seal the communication hole 31. The elastic sealing cap 42 has a sealing cap cavity 43 with an opening facing the face cover. Since the elastic sealing cap 42 is convex bump protruding towards the water outlet disk 3 and formed by recessing a side of the water outlet jacket 4 facing the face cover 5, the sealing cap cavity 43 with an opening facing the face cover 5 is formed inside the elastic sealing cap 42. The recessed portion 421 at the top of the elastic sealing cap 42 forms a protrusion protruding toward the sealing cap cavity 43, and the annular sealing portion 422 forms an annular notch 431 around the protrusion in the sealing cap cavity 43. The support structure 52 includes a support rib protruding toward the sealing cap cavity 43, and the support rib is annularly arranged to form a central cavity 523 at a central position. The support rib includes a first rib portion 521 and a second rib portion 522 above the first rib portion 521, and the second rid portion 522 corresponds to the annular notch 431. A width of the second rib portion 522 in a radial direction is less than a width of the first rib portion 521, the second rib portion 522 being located above the first rib portion 521 means that the second rib portion 522 is further away from a body of the face cover 5 relative to the first rib portion 521, and the second rib portion 522 corresponding to the annular notch 431 means that the positions of the second rib portion 522 and the annular notch 431 correspond with each other in a direction away from the face cover 5. Since the annular notch 431 has a narrow top and a wide bottom, and the narrow second rib portion 522 is provided, the second rib portion 522 can easily enter the annular notch 431 when the sealing cap 42 is pressed by water to deform towards the central cavity of the support structure.

It can be understood that the structure of the elastic sealing cap 42 may not be limited to the above-mentioned structure as long as it can be deformed under the action of water pressure to open the communication hole 31. The structure of the support structure 52 is not limited to the above-mentioned structure. For example, the support structure 52 may also be in the form of a spring or an elastic sheet. After the elastic sealing cap 42 is pressed and deformed by water pressure and supported on the support structure 52, the spring or the elastic sheet is also pressed to deform, and when the showerhead is turned off, the elastic sealing cap 42 can immediately bounce up under the action of its own elasticity and the elasticity of the support structure 52 to realize water stop.

In an embodiment, the showerhead also includes a sealing disk 2, and a first water cavity 20 is formed between the sealing disk 2 and the water outlet disk 3. The first water cavity 20 includes a central water cavity 201 at the center of the water outlet disk 3 and a plurality of first water division cavities 202 communicated with the central water cavity 201 and arranged along a circumferential direction. The plurality of communication holes 31 are divided into a plurality of groups, and each first water division cavity 202 corresponds to one group of communication holes 31. The central water cavity 201 is communicated with water inlet hole(s) 231 in the central portion of the sealing disk 2, and the water supply of the showerhead enters the central water cavity 201 from the water inlet hole(s) 231 and is then dispersed to each of the first water division cavities 202, so that the water outlet from the communication holes 31 is uniform.

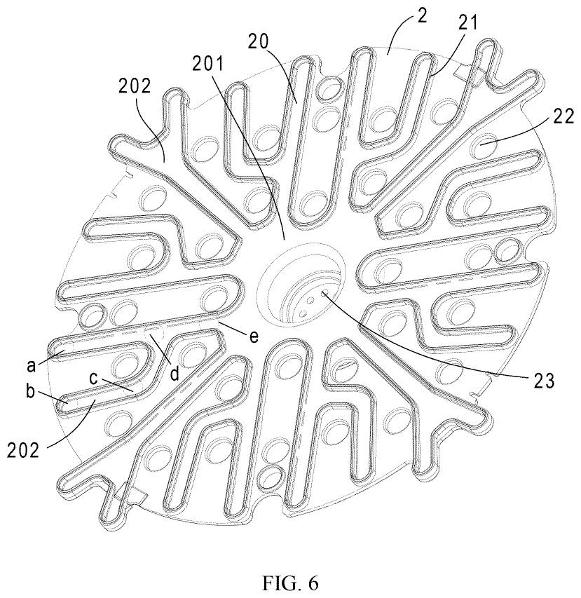

As shown in FIG. 6, in order to form the first water cavity 20 between the sealing disk 2 and the water outlet disk 3, a first water barrier strip 21 is provided on a surface of the sealing disk 2 facing the water outlet disk 3. The first water barrier strip 21 abuts against the water outlet disk 3, thereby forming the central water cavity 201 and the plurality of first water division cavities 202 between the sealing disk 2 and the water outlet disk 3.

In the example shown in FIG. 6, the first water division cavity 202 includes a plurality of communication hole regions and a channel which communicates two adjacent communication hole regions, and the plurality of communication hole regions are respectively in one-to-one correspondence with the plurality of communication holes in one group of communication holes 31. FIG. 6 illustrates five communication hole regions a, b, c, d and e in one first water division cavity 202, the five communication hole regions are in one-to-one correspondence with five communication holes in one group of communication holes 31 respectively, and the adjacent communication hole regions are communicated through the channel. This water cavity partition mode enables the long channel to be provided between the communication hole regions to realize water communication, thus making the first water division cavity as small as possible when corresponding to one group of communication holes with the same quantity of communication holes, so as to leave as little residual water in each first water division cavity as possible when the showerhead is turned off, which is beneficial to realize quick water stop.

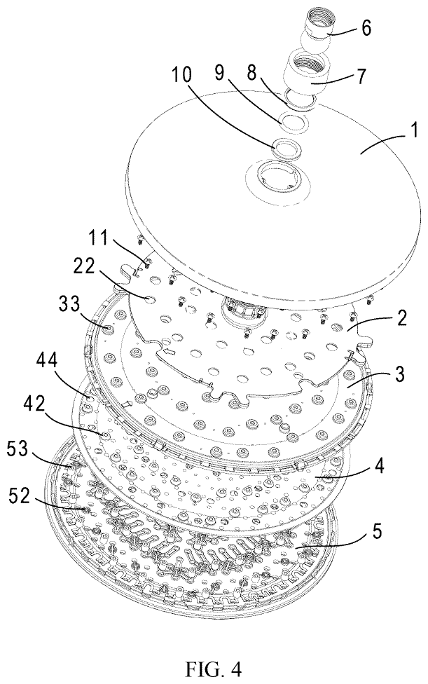

In an embodiment, the sealing disk 2, the water outlet disk 3, the water outlet jacket 4 and the face cover 5 are fixed together by bolts 11. As shown in FIGS. 4-11, the sealing disk 2 is provided with a plurality of bolt holes 22, the water outlet disk 3 is provided with a plurality of first passage holes 33, the water outlet jacket 4 is provided with a plurality of second passage holes 44, and the face cover 5 is provided with a plurality of bolt fixing posts 53 on the side facing the water outlet jacket 4. The plurality of bolts 11 respectively pass through the bolt holes 22 on the sealing disk 2, the first passage holes 33 on the water outlet disk 3 and the second passage holes 44 on the water outlet jacket 4 in sequence, and then are fixed to the bolt fixing posts 53 on the face cover 5, such that the sealing disk 2, the water outlet disk 3, the water outlet jacket 4 and the face cover 5 are fixed together.

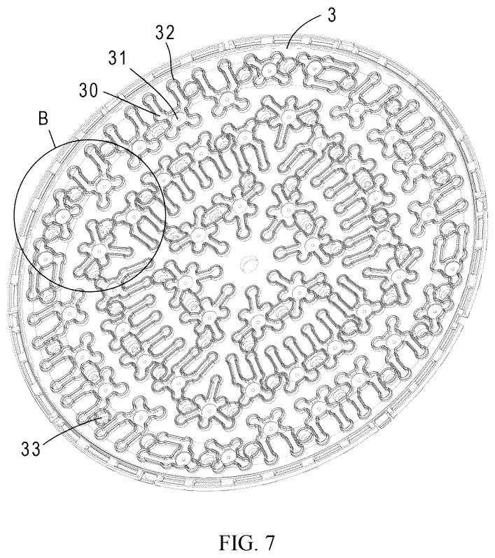

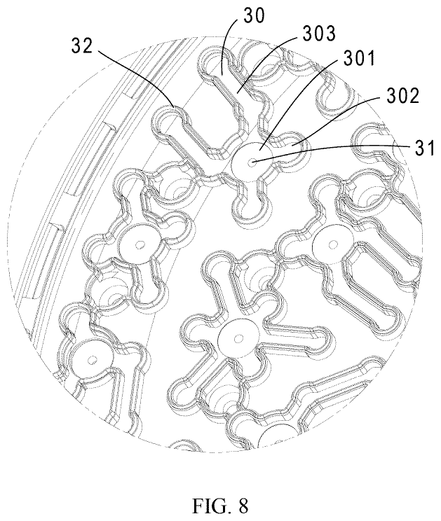

In an embodiment, a second water cavity 30 is formed between the water outlet disk 3 and the water outlet jacket 4. The second water cavity 30 includes a plurality of second water division cavities, which are communicated with a plurality of communication holes 31 in one-to-one correspondence, and each second water division cavity is correspondingly communicated with one group of water outlet nozzles 41. In order to form the second water cavity 30, as shown in FIGS. 7 and 8, a second water barrier strip 32 is provided on a surface of the water outlet disk 3 facing the water outlet jacket 4. The second water barrier strip 32 abuts against the water outlet jacket 4 and divides a space between the water outlet disk 3 and the water outlet jacket 4 to form a plurality of second water division cavities. Each second water division cavity is correspondingly communicated with one communication hole 31, so that the water supply from each communication hole 31 flows to a corresponding second water division cavity, and then the second water division cavity supplies water to a corresponding group of water outlet nozzles 41, thereby ensuring uniform water outlet from each water outlet nozzle 41.

In the example shown in FIGS. 7 and 8, each second water division cavity includes a central region 301 corresponding to one communication hole 31, a plurality of water outlet regions 302, and channels 303 communicating the plurality of water outlet regions 302 to the central region 301. The plurality of water outlet regions 302 respectively are in one-to-one correspondence with the plurality of water outlet nozzles 41 in one group of water outlet nozzles 41. The central region 301 may be a substantially circular region around the communication hole 31, the water outlet regions 302 may be substantially circular regions around the holes on the water outlet nozzles 41, and the channel 303 may be configured to have a width less than a diameter of the water outlet region 302. The arrangement mode of the second water division cavity can make the second water division cavity as small as possible under the condition that the second water division cavity corresponds to a group of water outlet nozzles with the same quantity of water outlet nozzles, so that the residual water in the second water division cavity is as small as possible when the showerhead is turned off, thereby facilitating the realization of quick water stop.

In an embodiment, as shown in FIGS. 1-5, the showerhead also includes a showerhead body 1 and a ball head assembly with a water inlet end. The showerhead body 1 and the face cover 5 form a cavity, and the sealing disk 2, the water outlet disk 3 and the water outlet jacket 4 are all located in the cavity between the showerhead body 1 and the face cover 5.

In the example shown in FIG. 2, the ball head assembly includes a connection sleeve 7 and a ball head 6 limited in the connection sleeve 7 by a ball head sleeve 8, and the ball head 6 has a water inlet end. The showerhead body 1 is sleeved on the central connection part 23 of the sealing disk 2, and the connection sleeve 7 is threaded with the central connection part 23 of the sealing disk 2 and abuts against the showerhead body 1, so that the showerhead body 1 and the face cover 5 are fitted and fixed together. A gasket 10 is provided between the ball head 6 and the central connection part 23, and a sealing ring 9 is provided between the ball head 6, the gasket 10 and the central connection part 23 to prevent water supply of the showerhead from leaking from the ball head assembly. The water entering from the water inlet end of the ball head 6 can enter the first water cavity 20 through water inlet hole(s) 231 of the central connection part 23 of the sealing disk 2, and then disperse from the central water cavity 201 of the first water cavity 20 to each first water division cavity 202. The water in each first water division cavity 202 flows to each second water division cavity of the second water cavity 30 through one group of communication holes 31, and then the water in each second water division cavity is sprayed from each water outlet nozzle 41.

An embodiment of the present application also provides a shower device including the showerhead as described above.

In the description of the present application, it should be noted that the orientations or position relationships indicated by the terms “upper”, “lower”, “one side”, “the other side”, “one end”, “the other end”, “edge”, “opposite”, “corner”, “periphery” and “square structure” or the like are based on the orientations or position relationships shown in the drawings, which are only for convenience of describing the present application and simplifying the description, and do not indicate or imply that the structure referred has a specific orientation, or is constructed and operated in the specific orientation, and thus cannot be interpreted as a limitation on the present application.

In the description of the embodiments of the present application, unless otherwise expressly specified and limited, the terms “connection”, “direct connection”, “indirect connection”, “fixed connection”, “mounting” and “assembly” should be understood in a broad sense. For example, they may be fixed connection, detachable connection or integrated connection. The terms “mounting”, “connection” and “fixed connection” may be direct connection, or indirect connection through an intermediary, or may be an internal communication between two elements. For those of ordinary skills in the art, the specific meanings of the aforementioned terms in the present application may be understood according to specific situations.

Although the disclosed implementations of the present application are described above, the described contents are implementations only for the convenience of understanding the present application and are not intended to limit the present application. Without departing from the spirit and scope disclosed herein, any person skilled in the art to which the present application pertains may make any modifications and changes in the form and details of implementation, but the scope of patent protection of the present application shall still be defined by the appended claims.

1. A showerhead, comprising a water outlet disk, a water outlet jacket and a face cover arranged in sequence along a water outlet direction, wherein a first water cavity is provided at a side of the water outlet disk facing away from the water outlet jacket, and a second water cavity is provided between the water outlet disk and the water outlet jacket;
wherein the water outlet disk is provided with a plurality of communication holes which are communicated with the first water cavity and the second water cavity on two sides of the water outlet disk, the water outlet jacket is provided with a plurality of water outlet nozzles communicated with the second water cavity, and the face cover is provided with a plurality of water outlet holes respectively in one-to-one correspondence with the water outlet nozzles;
wherein the water outlet jacket is also provided with a plurality of elastic sealing caps protruding towards the communication holes and in one-to-one correspondence with the communication holes; a plurality of support structures in one-to-one correspondence with the elastic sealing caps are provided at a side of the face cover facing the water outlet jacket; the elastic sealing caps are configured to block the communication holes when the showerhead is turned off; when the showerhead is turned on, the elastic sealing caps are capable of being pressed and deformed by the water passing through the communication holes to open the communication holes; and the support structures are configured to support the elastic sealing caps when the elastic sealing caps are pressed and deformed, so that the elastic sealing caps are able to bounce up and block the communication holes when the showerhead is turned off.

2. The showerhead according to claim 1, wherein a top of each of the elastic sealing caps is formed with a recessed portion and an annular sealing portion around the recessed portion, and the annular sealing portion abuts against the water outlet disk around a communication hole to seal the communication hole.

3. The showerhead according to claim 1, wherein each of the support structures has a central cavity, and each of the elastic sealing caps is deformed towards the central cavity when the elastic sealing cap is pressed by water passing through a communication hole.

4. The showerhead according to claim 3, wherein each of the support structures comprises a support rib around the central cavity, and each of the support structures is provided with a communication opening that communicates the central cavity to outside.

5. The showerhead according to claim 2, wherein each of the elastic sealing caps has a sealing cap cavity with an opening facing the face cover, the recessed portion forms a protrusion protruding into the sealing cap cavity, and the annular sealing portion forms an annular notch around the protrusion in the sealing cap cavity;
wherein each of the support structures comprises a support rib protruding toward the sealing cap cavity, the support rib is annularly arranged to form a central cavity at a central position, the support rib comprises a first rib portion and a second rib portion located above the first rib portion, the second rib portion corresponds to the annular notch, and a width of the second rib portion in a radial direction is less than a width of the first rib portion.

6. The showerhead according to claim 1, wherein the showerhead further comprises a sealing disk, and the first water cavity is formed between the sealing disk and the water outlet disk;
wherein, the first water cavity comprises a central water cavity at a central position of the water outlet disk and a plurality of first water division cavities communicated with the central water cavity and arranged along a circumferential direction, the plurality of communication holes are divided into a plurality of groups, and each of the first water division cavities corresponds to one group of communication holes.

7. The showerhead according to claim 6, wherein each of the first water division cavities comprises a plurality of communication hole regions and a channel connecting two adjacent communication hole regions; and the plurality of communication hole regions respectively are in one-to-one correspondence with a plurality of communication holes in one group of communication holes.

8. The showerhead according to claim 6, wherein a raised first water barrier strip is provided on a surface of the sealing disk facing the water outlet disk, the first water barrier strip abuts against the water outlet disk to form the central water cavity and the plurality of first water division cavities.

9. The showerhead according to claim 1, wherein the second water cavity comprises a plurality of second water division cavities which are communicated with the plurality of communication holes in one-to-one correspondence respectively, the plurality of water outlet nozzles are divided into a plurality of groups, and each of the second water division cavities is correspondingly communicated with one group of water outlet nozzles.

10. The showerhead according to claim 9, wherein each of the second water division cavities comprises a central region corresponding to the communication hole, a plurality of water outlet regions, and channels for communicating the plurality of water outlet regions to the central region, wherein the plurality of water outlet regions are in one-to-one correspondence with a plurality of water outlet nozzles in one group of water outlet nozzles respectively.

11. The showerhead according to claim 9, wherein a second water barrier strip is provided on a surface of the water outlet disk facing the water outlet jacket, and the second water barrier strip abuts against the water outlet jacket to divide a space between the water outlet disk and the water outlet jacket so as to form the plurality of second water division cavities.

12. The showerhead according to claim 2, wherein the showerhead further comprises a sealing disk, and the first water cavity is formed between the sealing disk and the water outlet disk;
wherein, the first water cavity comprises a central water cavity at a central position of the water outlet disk and a plurality of first water division cavities communicated with the central water cavity and arranged along a circumferential direction, the plurality of communication holes are divided into a plurality of groups, and each of the first water division cavities corresponds to one group of communication holes.

13. The showerhead according to claim 3, wherein the showerhead further comprises a sealing disk, and the first water cavity is formed between the sealing disk and the water outlet disk;
wherein, the first water cavity comprises a central water cavity at a central position of the water outlet disk and a plurality of first water division cavities communicated with the central water cavity and arranged along a circumferential direction, the plurality of communication holes are divided into a plurality of groups, and each of the first water division cavities corresponds to one group of communication holes.

14. The showerhead according to claim 4, wherein the showerhead further comprises a sealing disk, and the first water cavity is formed between the sealing disk and the water outlet disk;
wherein, the first water cavity comprises a central water cavity at a central position of the water outlet disk and a plurality of first water division cavities communicated with the central water cavity and arranged along a circumferential direction, the plurality of communication holes are divided into a plurality of groups, and each of the first water division cavities corresponds to one group of communication holes.

15. The showerhead according to claim 5, wherein the showerhead further comprises a sealing disk, and the first water cavity is formed between the sealing disk and the water outlet disk;
wherein, the first water cavity comprises a central water cavity at a central position of the water outlet disk and a plurality of first water division cavities communicated with the central water cavity and arranged along a circumferential direction, the plurality of communication holes are divided into a plurality of groups, and each of the first water division cavities corresponds to one group of communication holes.

16. The showerhead according to claim 2, wherein the second water cavity comprises a plurality of second water division cavities which are communicated with the plurality of communication holes in one-to-one correspondence respectively, the plurality of water outlet nozzles are divided into a plurality of groups, and each of the second water division cavities is correspondingly communicated with one group of water outlet nozzles.

17. The showerhead according to claim 3, wherein the second water cavity comprises a plurality of second water division cavities which are communicated with the plurality of communication holes in one-to-one correspondence respectively, the plurality of water outlet nozzles are divided into a plurality of groups, and each of the second water division cavities is correspondingly communicated with one group of water outlet nozzles.

18. The showerhead according to claim 4, wherein the second water cavity comprises a plurality of second water division cavities which are communicated with the plurality of communication holes in one-to-one correspondence respectively, the plurality of water outlet nozzles are divided into a plurality of groups, and each of the second water division cavities is correspondingly communicated with one group of water outlet nozzles.

19. The showerhead according to claim 5, wherein the second water cavity comprises a plurality of second water division cavities which are communicated with the plurality of communication holes in one-to-one correspondence respectively, the plurality of water outlet nozzles are divided into a plurality of groups, and each of the second water division cavities is correspondingly communicated with one group of water outlet nozzles.

20. A shower device, comprising the showerhead according to claim 1.
